(19) United States
(12) Patent Application Publication
(10) Pub. No.: US 2005/0266202 A1
(43) Pub. Date: Dec. 1, 2005

(54) Optical recording medium substrate and method of injection molding same

(75) Inventors: Hua Chieh Chen, Hsinchu (TW); Chin Chang Lin, Hsinchu (TW)

Correspondence Address: BACON & THOMAS, PLLC, 625 SLATERS LANE, FOURTH FLOOR, ALEXANDRIA, VA, 22314, US

(73) Assignee: GIGASTORAGE CORPORATION, Hsinchu County (TW)

(21) Appl. No.: 10/990,469

(22) Filed: Nov. 18, 2004

(30) Foreign Application Priority Data
May 31, 2004 (TW) 93115465

(51) Int. Cl. B29D 11/00

(52) U.S. Cl. 428/64.4; 264/1.33

(57) ABSTRACT

A method of injection molding an optical recording medium substrate of 0.4 mm thickness. The method comprises: applying a mold clamping force of predetermined level after closing movable and stationary mold halves to define a mold cavity; injecting a given quantity of molten plastic material into the mold cavity at a first higher injection velocity and a second lower injection velocity; increasing mold clamping force after the injection at the first injection velocity so that the mold clamping force is 25 to 30 tons for a first predetermined period of time after the completion of the injection at the second injection velocity, and then decreasing the mold clamping force to between 15 to 25 tons for a second predetermined period of time; and after the completion of the injection of the molten material, maintaining an injection holding pressure between 10 to 15 kg/cm² and simultaneously cooling the molten material to form a substrate.

### FIELD OF THE INVENTION

The present invention relates to an optical recording medium substrate having a thickness of 0.4 mm and a method of injection molding the substrate.

### BACKGROUND OF THE INVENTION

Write-once type optical data storage discs such as compact disc-recordable (CD-R) in accordance with the Orange Book standard has an outer diameter of 8 cm or 12 cm and a thickness of 1.2 mm. Mass production of CD-R is usually achieved by injection molding technology. Injection molding a CD-R generally comprises: using an injection molding machine including a mold with a stamper having certain data patterns or pre-grooves on one of its surfaces and fixed inside the mold; injecting molten polycarbonate or other suitable material into the mold, thereby molding a round substrate having a diameter of 8 or 12 cm and a thickness of 1.2 mm while transferring pre-grooves from the stamper onto one of the surfaces of the substrate. The formed substrate is subject to subsequent process, including sputtering an organic dye recording layer, coating a metal reflective layer and a protective lacquer layer onto the pre-grooved surface of the substrate in sequence, and thus a CD-R is obtained. The total thickness of these added layers is small, less than about 0.06 mm. Data may be recorded onto or retrieved from the CD-R by using write-read apparatus.

Current DVD-R (Digital Versatile Disc-Recordable) also has a diameter of 8 cm or 12 cm and a thickness of 1.2 mm. However, the DVD-R is formed by bonding together two substrates each having a thickness of 0.6 mm. The substrates may be made by the same process as those for CD-R.

The existing optical data recording media substrate has a thickness of at least 0.6 mm. It is desirable to provide a more compact and thinner substrate for optical data recording medium.

### SUMMARY OF THE INVENTION

An object of the instant invention is to provide a compact and thin optical data recording medium, particularly an optical data recording medium of 0.4 mm thickness. The optical data recording medium can be adapted to be incorporated into anti-theft or anti-forgery system for an article in a manner like that used in perforation, barcode or integrated circuit chip, yet may contain larger contents therein.

Another object of the invention is to provide a method of injection molding an optical recording medium substrate of 0.4 mm thickness.

According to the invention, a method of injection molding an optical recording medium substrate of 0.4 mm thickness comprises the steps of:
providing a mold having a movable mold half and a stationary mold half, a stamper with pre-grooves being attached to the movable mold half; closing the mold to define a mold cavity; applying a mold clamping force of predetermined level to the mold after closing the mold; injecting a given quantity of molten plastic material into the mold cavity at a first injection velocity and a second injection velocity differing from the first injection velocity; increasing mold clamping force after the injection of the molten material at the first injection velocity so that the mold clamping force is about 25 to 30 tons for a first predetermined period of time after the completion of the injection of the molten material at the second injection velocity, and then decreasing the mold clamping force to between about 15 to 25 tons for a second predetermined period of time; and after the completion of the injection of the molten material, maintaining an injection holding pressure between about 10 to 15 kg/cm² for a period of time and simultaneously cooling the molten material to form a substrate having on one of its surfaces pre-grooves transferred from the stamper.

In one embodiment of the invention, the temperature of the movable mold half is set to between 105 and 115° C., and the temperature of the stationary mold half is set to between 123 and 130° C. The first injection velocity is set to 150 mm/sec and the second injection velocity is set to 100 mm/sec. The mold clamping force is elevated to about 30 tons for 0.2 second after the completion of the injection of the molten material at the second injection velocity, and then reduced to about 20 tons till the removal of mold clamp force. The injection holding pressure is set to about 12 kg/cm².

### BRIEF DESCRIPTION OF THE DRAWINGS

FIG. 1 depicts a cross-sectional view of an injection molding mold suitable for use in practicing the invention;

FIG. 2 depicts an injection molding process of an optical data recording medium substrate according to the invention;

FIG. 3 is graph showing the change of mold clamp force, injection velocity and injection holding pressure over time when injection molding an optical data recording disc substrate of the invention;

FIG. 4 depicts a cross-sectional view of an optical data recording disc substrate of the invention;

FIG. 5 depicts a cross-sectional view of an article having embedding therein a data chip that is cut from an optical data recording disc of the invention already having data recorded thereon; and

FIG. 6 is a top plan view of the article of FIG. 5.

### DETAILED DESCRIPTION OF THE PREFERRED EMBODIMENT

A process of injection molding an optical data recording disc substrate having a diameter of 8 cm and a thickness of 0.4 mm in accordance with an embodiment of the present invention will be described hereinafter.

A general injection molding machine for optical disc (for example, the injection machine type SD-30, SD-40 or SD-40E manufactured by Sumitomo Company, Japan) may be used for injection molding the optical disc substrate of the invention. A mold suitable for injection molding the disc substrate of 0.4 mm thickness of the invention may be obtained by modifying an existing mold for injection molding a DVD substrate of 0.6 mm thickness, for example, by adding a thickness of 0.2 mm to a mirror plate of a moving side mold half of the DVD mold so that its thickness is changed from 19.998 mm to 20.198 mm, reducing the thickness of a moving side bush from 19.956 mm to 19.533 mm, and changing the thickness of a stamper ring holder from 6.682 mm to 6.832 mm, etc.

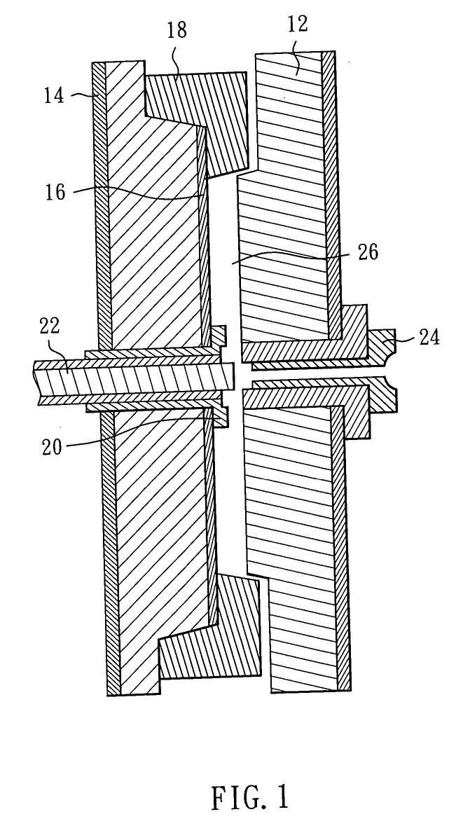

FIG. 1 illustrates a mold used for the invention, including a stationary mold half 12 and a movable mold half 14 together defining a mold cavity 26, a floating punch 22, a sprue bush 24, and a stamper 16 held by inner and outer ring holders (20, 18). The stamper 16 has on its exposed surface certain data pattern or pre-grooves like that of existing CD-R, which will be transferred onto one surface of a substrate molded in the mold cavity.

Polycarbonate (PC) material is used for producing the substrate of the invention. The PC material is heated to a temperature between 330 and 399° C. at an injection unit (not shown) of the injection molding machine, and between 330 and 350° C. at an injection nozzle of the injection unit. The temperature of the movable mold half is set to between 105 and 115° C. and the temperature of the stationary mold half is set to between 123 and 130° C.

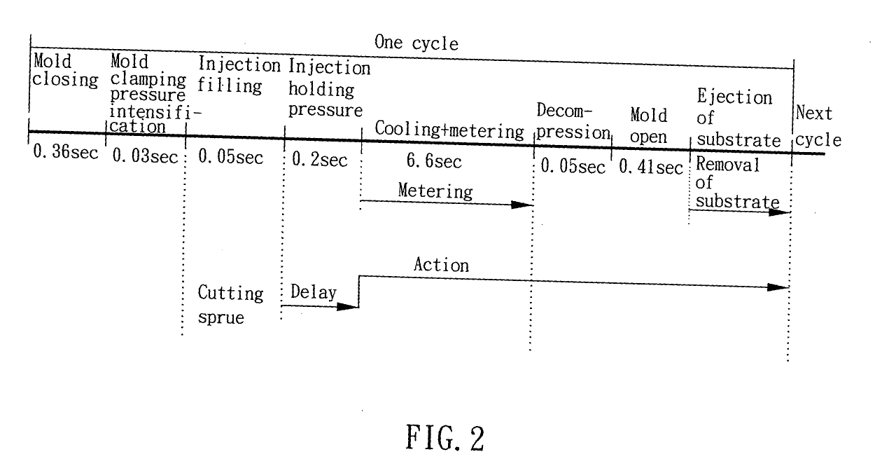

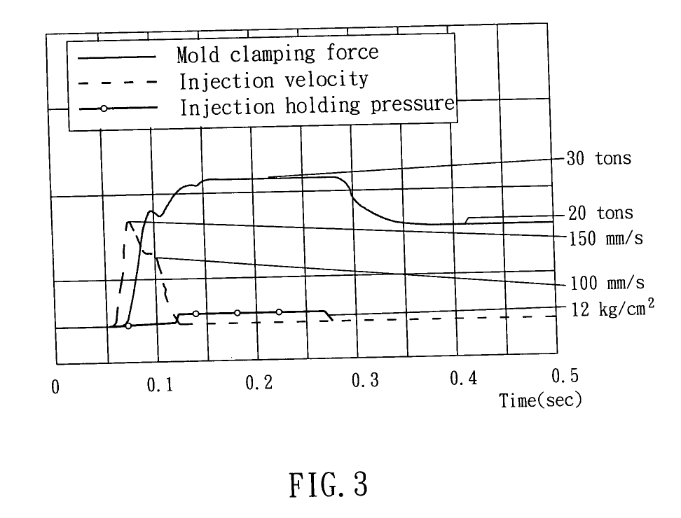

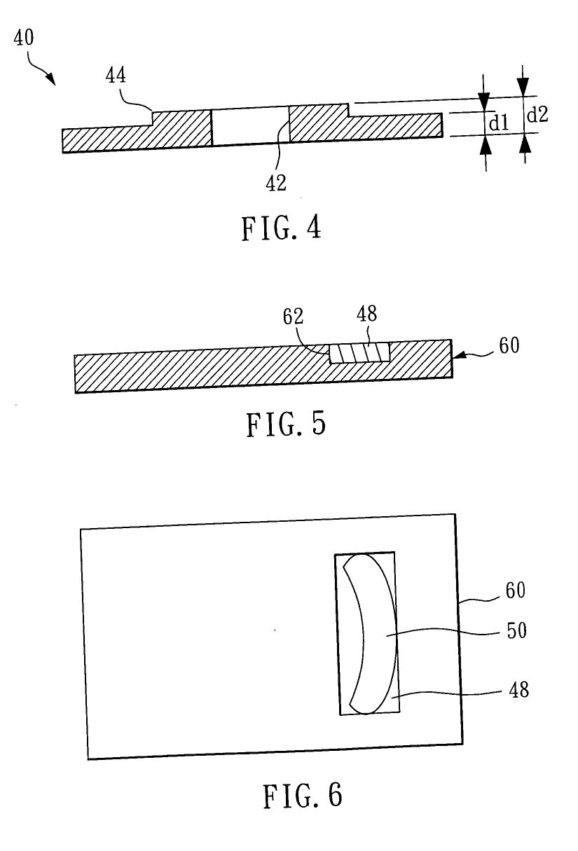

Referring to FIGS. 2 to 4, the mold is closed 0.36 seconds after starting mold closing operation. Mold clamping force is increased to a level of about 0.1 ton when a given quantity of PC melt is injected into the mold cavity 26 through the injection unit. The PC melt is injected at a first higher injection velocity of between 150 and 200 mm/sec and a second lower velocity of 100 mm/sec, respectively, and the injection is completed within about 0.05 second. Injection holding pressure is applied at a level of between 10 and 15 kg/cm² for 0.2 second.

The mold clamping force is increased after the injection filling at the first injection velocity and reaches at between 25 and 30 when finishing the injection at the second velocity. This mold clamping force is maintained for a period of time and then decreased to between 15 and 25 tons, which is maintained through decompression of the mold. A cooling operation begins upon the completion of the injection operation. When a substrate has been formed in the mold cavity, the mold clamping force is released, the mold is opened, and the substrate is taken out of the mold. One such molding cycle takes about 8.25 seconds.

According to a preferred embodiment of the method of the invention, the temperature of the movable mold half is set to 110 and 126° C. for the stationary mold half. The PC melt is injected into the mold cavity at a first higher injection velocity of 150 mm/sec, followed by a second lower injection velocity of 100 mm/sec. Upon the completion of the injection, the injection holding pressure is maintained at a level of 12 kg/cm² for 0.2 second. The mold clamping force reaches 30 tons when finishing the injection at the second velocity. This mold clamping force is maintained for 0.2 second and then decreased to 20 tons, which is maintained for 6.8 seconds until decompression.

FIG. 5 illustrates a round disc substrate 40 made according to the method of the invention. Substrate 40 has an outer diameter of 8 cm, a center aperture 42 having a diameter of 15 mm, a hub 44 having a thickness d₂ of 0.6 mm, and a data recording area 46 having a thickness d₁ of 0.4 mm.

The formed substrate 40 is subject to subsequent processing, like the production of an existing CD-R, including sputtering dye recording layer on the pre-grooved surface of the substrate, coating reflecting layer on the recording layer, coating protective resin on the reflecting layer, etc., so as to obtain a write-once recordable disc.

An application of the disc having 0.4 mm thickness according to the invention is described hereinafter. Desired digital data is written onto or read from the disc through a specific write-read apparatus which is basically the same as that used for existing CD-R, using same write-read device and laser beam wavelength (780 nm). However, the firmware for known write-read apparatus needs modification in order to be incorporated in the specific write-read apparatus to enable the apparatus to write data on the disc in a plurality of interrupted data sections on the data recording area or to read the data therefrom. Besides, the mechanism for known write-read apparatus also needs to be modified in order to be used in the specific write-read apparatus to enable write-read laser beam to focus on the data recording layer of the disc of 0.4 mm thickness.

The disc 40 with desired data recorded in a plurality of interrupted data sections is then cut into a plurality of data chips 48 as shown in FIGS. 5 and 6 by a punching machine or appropriate cutting machine so that each data chip 48 contains a data section 50. Data chip 48 may have a rectangular shape as shown in the drawings or other shape if desired. Data chip 48 may be attached to an article 60, for example, by having the chip received and bonded in a corresponding rectangular recess 62 formed in a surface of the article 60, with the chip being flushed with the article.

The data contained in the data chip is relevant to the article incorporating the chip, such as any information for identifying the article or for anti-theft purpose, and can be retrieved by using a specific read apparatus mentioned above.

It is advantageous that the disc or the data chip of the invention is easy to manufacture and the cost therefore is low as compared with conventional integrated circuit cards (IC cards or smart cards). Furthermore, it is apparent that the disc or data chip of the invention can be easily incorporated into other products and thus may have wide applications.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

1. A method of injection molding an optical recording medium substrate of 0.4 mm thickness using an injection molding machine, the method comprising the steps of:
providing a mold having a movable mold half and a stationary mold half, a stamper with pre-grooves being attached to the movable mold half;
closing the mold halves to define a mold cavity;
injecting a given quantity of molten plastic material into the mold cavity at a first higher injection velocity and a second lower injection velocity, respectively, after applying a mold clamping force of predetermined level to the closed mold halves;
increasing mold clamping force after the injection of the molten material at the first injection velocity so that the mold clamping force is about 25 to 30 tons for a first predetermined period of time after the completion of the injection of the molten material at the second injection velocity and then decreasing the mold clamping force to between about 15 to 25 tons for a second predetermined period of time;
maintaining an injection holding pressure between about 10 to 15 kg/cm² for a period of time after the completion of the injection of the molten material, and simultaneously cooling the molten material to form a substrate having on one of its surfaces pre-grooves transferred from the stamper.

2. The method as claimed in claim 1, wherein the plastic material is polycarbonate.

3. The method as claimed in claim 2, wherein the plastic material is heated to 300 and 399° C. at an injection unit of the injection molding machine.

4. The method as claimed in claim 3, wherein the temperature of the movable mold half is set to between 105 and 115° C. and the temperature of the stationary mold half is set to between 123 and 130° C.

5. The method as claimed in claim 4, wherein the first injection velocity is between 150 and 200 mm/sec and the second injection velocity is 100 mm/sec.

6. The method as claimed in claim 1, wherein the mold clamping force is elevated to about 30 tons for 0.2 second after the completion of the injection of the molten plastic material at the second injection velocity, and then reduced to about 20 tons till the removal of mold clamping force.

7. The method as claimed in claim 1, wherein the injection holding pressure is set to about 12 kg/cm² for 0.2 second.

8. An optical recording medium substrate of 0.4 mm thickness made by the method as claimed in claim 1.

9. The substrate as claimed in claim 8, wherein the substrate is subject to the processing including sputtering dye recording layer on the pre-grooved surface of the substrate, coating reflecting layer on the recording layer, and coating protective resin on the reflecting layer to obtain a write-once recordable disc.

10. The substrate as claimed in claim 9, wherein the disc has a data recording area including a plurality of interrupted data sections.

11. The substrate as claimed in claim 10, wherein the disc may be cut into a plurality of data chips each containing a data section.

12. The substrate as claimed in claim 12, wherein the data chip may be attached to a product.
